(19) United States
(12) Patent Application Publication
(10) Pub. No.: US 2026/0042197 A1
(43) Pub. Date: Feb. 12, 2026

(54) Machine tool with a sealing device

(71) Applicant: Hilti Aktiengesellschaft, Schaan (LI)

(72) Inventors: Manfred EGE, Steingaden (DE); Rory BRITZ, Starnberg (DE); Ulrich MANDEL, Buchloe Honsolgen (DE); Uwe HAINKE, Dresden (DE)

(21) Appl. No.: 19/103,076

(22) PCT Filed: Aug. 2, 2023
(86) PCT No.: PCT/EP2023/071433

§ 371 Date: Feb. 11, 2025

(30) Foreign Application Priority Data
Aug. 29, 2022 (EP) 22192592.8

(51) Int. Cl. B25D 17/04; B25D 17/20

(52) U.S. Cl. CPC B25D 17/043; B25D 17/20; B25D 2222/57; B25D 2250/121; B25D 2250/365

(57) ABSTRACT

A machine tool (1), in particular a drill hammer or chisel hammer, is described having a housing (5) having a grip region (7, 27) and an assembly (9) including an impact mechanism (11) and a drive device (13), the assembly (9) being arranged substantially within the housing (5) and being arranged movably relative to the housing (5). A center of gravity (15) of the assembly (9) is arranged at a distance from an impact axis (19). A sealing device (87) is provided to restrict an air flow between the assembly (9) and the housing (5), wherein the sealing device (87) is connected to the assembly (9) and to the housing (5) and encompasses the assembly (9) circumferentially relative to a vertical direction (Y) of the machine tool (1).

The present invention relates to a machine tool, in particular a drill hammer and/or chisel hammer.

### BACKGROUND

Machine tools, in particular drill and/or chisel hammers, are known from practice in which a housing is provided that has an impact mechanism and a drive device and is vibration-decoupled from electronics and a battery interface device. In order to prevent entrance of dust into the region having the electronics, a uniaxially acting air barrier, for example in the form of a rubber sleeve, with a line of action in the longitudinal direction of the machine tool, is known.

DE 10 2020 216 538 A1 discloses a drill hammer and/or chisel hammer having an outer housing and an inner housing. The inner housing is arranged in the outer housing, wherein the inner housing has a drive unit and an impact unit. A vibration damping unit with a vibration damping element for damping vibrations occurring during operation is provided, by means of which a main handle connected to the outer housing is decoupled from the inner housing. The inner housing is rotatably mounted relative to the outer housing about an axis of rotation arranged in the region of an instantaneous center of rotation of the impact unit.

### SUMMARY OF THE INVENTION

In such an embodiment, the provision of such a uniaxial air barrier is disadvantageous since it merely compensates for vibrations in the longitudinal direction and is also arranged in a lower region of the machine tool, which is unfavorable in terms of installation space.

It is an object of the present invention to provide a machine tool, in particular a drill hammer or a chisel hammer, in a machine tool having an assembly which is mounted movably relative to a housing, to achieve a seal between the assembly and the housing that is advantageous in terms of installation space during a movement of the assembly relative to the housing in different spatial directions.

The present invention provides a machine tool, in particular a drill hammer or chisel hammer, is provided having a housing having a grip region and an assembly comprising an impact mechanism and a drive device, the assembly being arranged substantially within the housing and being arranged movably relative to the housing, wherein a center of gravity of the assembly is arranged at a distance from an impact axis.

According to the invention, a sealing device is provided to restrict and in particular to substantially completely prevent an air flow between the assembly and the housing, wherein the sealing device is connected to the assembly and to the housing and encompasses the assembly circumferentially relative to a vertical direction of the machine tool.

With a machine tool designed according to the invention, the positioning and design of the sealing device achieves a seal advantageous in terms of installation space between the assembly and the housing during a movement of the assembly relative to the housing when there are large deflections in the longitudinal direction and in particular comparatively smaller deflections in the vertical direction and/or transverse direction of the machine tool.

As a result of the arrangement according to the invention of the sealing device surrounding the vertical direction, the sealing device can advantageously handle large movements of the assembly relative to the housing in a vertical direction and/or a transverse direction in addition to compensating for movements of the assembly relative to the housing in the longitudinal direction and thereby reliably seal between the assembly and the housing.

A machine tool designed according to the invention has the advantage that air circulation in the region of a suction and blow-out region of the drive device and also electrical connections of the drive device and the electrical system are not negatively influenced by the sealing device, and a maximum cross-section for cooling air is available for the drive device.

Furthermore, the arrangement according to the invention of the sealing device makes it easy to achieve favorable cooling of a stator by means of cooling which can be adjusted substantially symmetrically to the vertical axis.

As a result of the circumferential arrangement of the sealing device relative to the vertical direction of the machine tool, a lower region of the machine tool in the vertical direction is free of the sealing device so that, for example, electrical connections and/or a cable harness and/or a dust extraction system can be easily arranged in this region.

A simple coupling of the sealing device to the housing and the assembly is achieved when the sealing device is connected fixedly to the housing with a first region and is connected fixedly to the assembly with a second region.

In an advantageous embodiment of the invention, the sealing device has a flexible element and a dimensionally stable element. The flexible element makes it possible to achieve the desired sealing effect, while the dimensionally stable element makes it easy to connect the sealing device to the housing with the corresponding geometry.

In an advantageous embodiment of the invention, the flexible element has at least two regions extending substantially in the vertical direction, which are connected to one another in the longitudinal direction. Such an embodiment of the sealing device allows large movements of the assembly relative to the housing in the longitudinal direction with simultaneous possible movement in the transverse and vertical direction.

The sealing device preferably has a U-shaped region in cross section. Depending on the dimensions, it is possible to easily adjust the possible movement of the assembly relative to the housing and adapt it to the available installation space. In this case, the U-shaped region can be designed to be open in the vertical direction at the top as well as in the vertical direction at the bottom.

A favorable connection of the sealing device to the assembly and/or the housing is achieved when the sealing device is connected to the assembly and/or the housing via a form-fit and/or a material-fit.

In an advantageous embodiment of a machine tool according to the invention, the sealing device engages with the first region and/or second region in a recess or groove of the housing or of the assembly, in particular in the longitudinal direction of the machine tool.

Alternatively or in addition thereto, it can be provided that the sealing device surrounds an element of the housing or the assembly with the first region and/or the second region.

In an advantageous embodiment of the invention, it is provided that the flexible element surrounds the dimensionally stable element in the circumferential direction of the vertical direction. This creates a simple connection between the elements which reliably prevents the passage of air in this region.

In an advantageous embodiment of a machine tool according to the invention, the flexible element is designed with an elastomer. The flexible element preferably represents a membrane, in particular with an elastomeric material.

In an advantageous embodiment of the invention, the dimensionally stable element is made with a plastic. In this way, a desired stability can be easily achieved. In principle, other materials such as metallic materials can also be used.

In an advantageous embodiment of a machine tool according to the invention, the sealing device is designed such that it allows a movement of the assembly relative to the housing in the longitudinal direction greater than 0.8 mm, in particular greater than 1.0 mm.

In an advantageous embodiment of a machine tool according to the invention, the sealing device is in a neutral or unbiased position when the assembly is in an approximately central position between two end positions with respect to the housing relative to the longitudinal direction. In this way, both movements of the assembly relative to the housing in the direction of the maximum deflection position and in the direction of the minimum deflection position can be easily compensated, and the sealing device seals reliably in all operating states between the assembly and the housing.

Further advantages can be found in the following description of the figures. Different exemplary embodiments of the present invention are shown in the figures. The figures, the description, and the claims contain numerous features in combination. A person skilled in the art will expediently also consider the features individually and combine them to form meaningful further combinations.

### BRIEF DESCRIPTION OF THE DRAWINGS p In the Drawings:

FIG. 1 shows a simplified lateral sectional view of a first embodiment of a machine tool designed as a drill hammer with an outer housing and an assembly arranged in the housing, comprising an impact mechanism and a drive device, the assembly being displaceable relative to the housing by means of a front decoupling apparatus and a rear decoupling apparatus, the assembly being shown in a position without external forces being applied; wherein a sealing device is provided for sealing between the assembly and the housing, and wherein the assembly is shown in a front end position relative to the housing without external force being applied;

FIG. 2 shows a view corresponding to FIG. 1 of the machine tool, the assembly being shown in a rear end position resting against a stop when there is action of an external force;

FIG. 3 shows a sectional view of the machine tool corresponding to FIGS. 1 and 2, the assembly being shown in a central position located substantially centrally between the front end position and the rear end position;

FIG. 4 shows a sectional view of the machine tool corresponding to FIG. 1 to FIG. 3, the assembly being rotated about a transverse axis relative to the housing when an external force is applied;

FIG. 5 shows a sectional view of the machine tool according to FIG. 1;

FIG. 6 shows a section of the machine tool according to FIG. 5, wherein the sealing device can be seen in more detail;

FIG. 7 shows a three-dimensional view of a section of the machine tool without the housing, wherein the sealing device can be seen in more detail;

FIG. 8 shows a three-dimensional view of a section of the machine tool, wherein a blow-out region and the sealing device can be seen in more detail;

FIG. 9 shows a sectional view of a section of the machine tool corresponding substantially to FIG. 7;

FIG. 10 shows a side view of the sealing device in isolation;

FIG. 11 shows a plan view of the sealing device according to FIG. 10 in isolation;

FIG. 12 shows a sectional view of the sealing device according to FIG. 10 and FIG. 11;

FIG. 13 shows a sectional view of the sealing device according to FIG. 10 to FIG. 12, wherein the sealing device is in a position with an assembly located in an end position relative to the housing, and

FIG. 14 shows another sectional view of the sealing device according to FIG. 10 to FIG. 13, wherein the sealing device is in a position with an assembly located in an end position relative to the housing.

### DETAILED DESCRIPTION

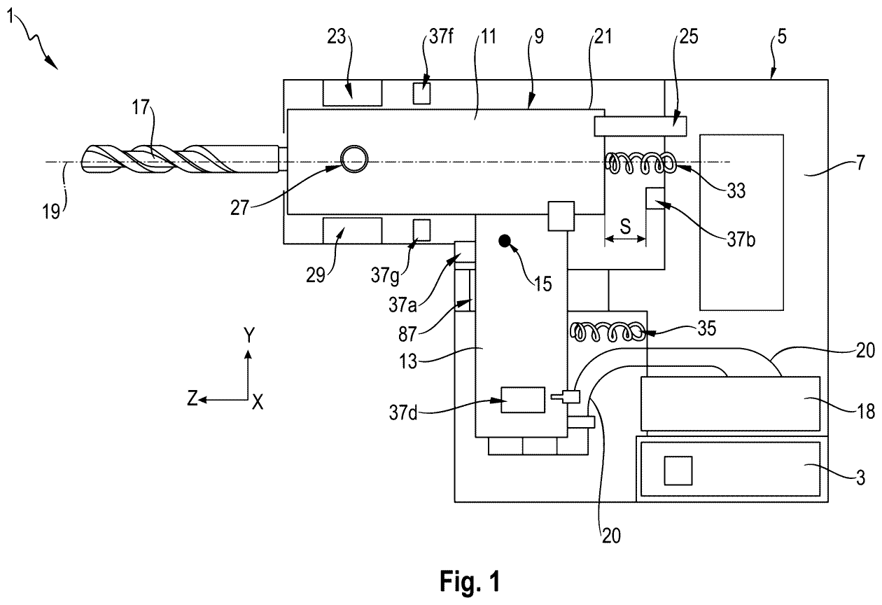

FIG. 1 to FIG. 4 show a machine tool 1, which in the present case is realized as a drill hammer or combination hammer, in an alternative embodiment for example also as a chisel hammer or the like.

In the present case, the machine tool 1 is designed as a cordless machine tool with an accumulator 3, and in an alternative embodiment can be provided for mains operation.

The machine tool 1 here has an angular design and has a housing 5 which has a rear grip region 7 in a D shape. The housing 5, which can be realized in one or more parts, is here fixedly connected to the grip region 7, which can be grasped by a user. In the present case, the housing 5 is divided in the longitudinal direction Z and has a so-called pot construction. Alternatively, the housing 5 can also have, in particular, two housing halves connectable to one another in the transverse direction X and having a so-called shell construction.

Arranged within the housing 5 is a structural unit or assembly 9, which has an impact mechanism 11 of conventional design and a drive device 13 designed as an electric motor, which is designed to drive the impact mechanism 11. In the present case, the assembly 9 is made L-shaped.

By means of the assembly 9, drilling or chisel operation is possible, whereby in chisel operation the tool 17 moves back and forth in oscillating fashion in an impact axis direction. In drilling or hammer drilling operation, the tool additionally executes a rotational movement about the impact axis.

Furthermore, an electronic system 18 can be seen which is connected to the drive device 13 in a known manner via lines 20.

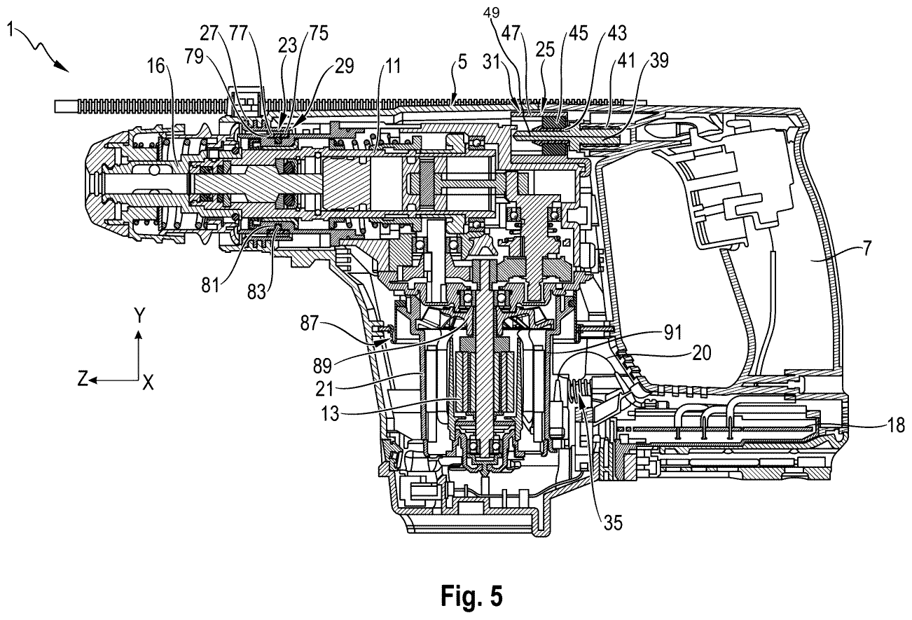

In a conventionally known manner, the machine tool 1 has a tool holder 16 (see, e.g., FIG. 5) via which a tool 17, for example a chisel or the like, can be detachably operatively connected to the structural unit 9.

The figures further show a longitudinal direction designated Z or Z-direction, a vertical direction designated Y or Y-direction, and a transverse direction designated X or X-direction. X, Y, and Z are axes of a Cartesian coordinate system and are perpendicular to one another. Without the action of an external force, the longitudinal direction Z is coincident with the impact axis 19, which is defined by a center axis of the tool or the tool holder 16.

In the embodiment shown, a center of gravity of the structural unit 9 is shown with 15, which is arranged below the impact axis 19 with respect to the vertical direction Y in the shown representations and is thus spaced at a distance from the impact axis 19.

The structural unit 9 can have a separate inner housing 21 which, in particular, comprises the impact mechanism 11 and the drive device 13 or within which the impact mechanism 11 and the drive device 13 are arranged in particular almost completely.

For example, FIG. 1 shows a front decoupling apparatus 23 and a rear decoupling apparatus 25, which can in principle be designed with one decoupling device or multiple decoupling devices. In the embodiment shown, the front decoupling apparatus 23 is arranged in front of the rear decoupling apparatus 25 in the longitudinal direction Z, i.e., closer to the tool holder 16 and in an area facing away from the rear grip area 7.

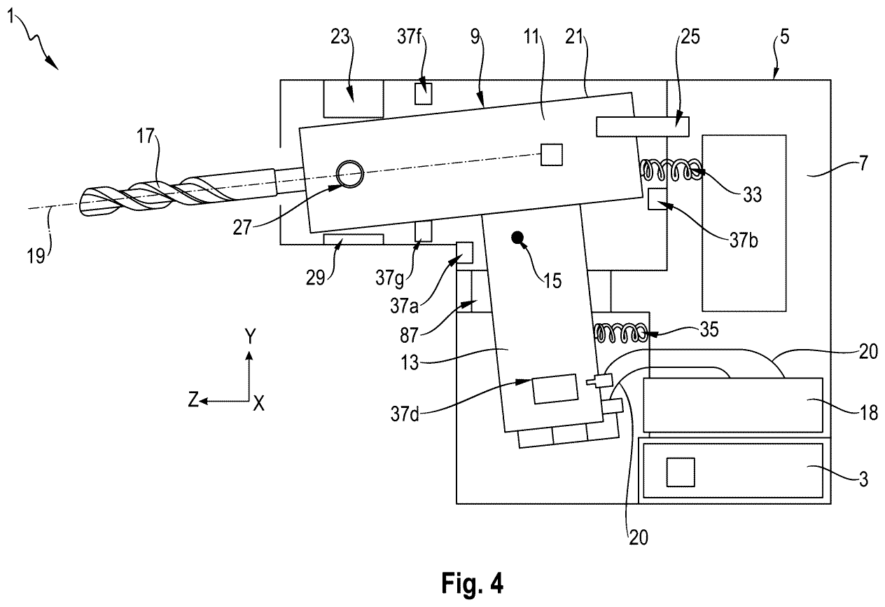

In FIG. 1 and FIG. 4, a front grip region 27 or lateral handle can be seen, which in the present case can be releasably brought into operative connection with the housing 5, for example by means of a clamping band, in the region of the front decoupling apparatus 23. In the present case, the front grip region 27 extends substantially in the transverse direction X, but can in particular be arranged on the housing 5 so as to be continuously adjustable in the circumferential direction relative to the longitudinal direction Z.

The structural unit 9 is mounted relative to the housing 5 both via the front decoupling apparatus 23 and also via the rear decoupling apparatus 25, wherein the structural unit 9 is displaceable relative to the housing 5 both in the region of the front decoupling apparatus 23 and in the region of the rear decoupling apparatus 25 in the longitudinal direction Z, in the transverse direction X, and in the vertical direction Y. The possibility of displacement S in the longitudinal direction Z is, for example, at most approximately 10 mm, but can also be up to 20 mm or greater in other embodiments. The possibility of displacement in the transverse direction X and in the vertical direction Y is substantially identical in the present case, wherein the possibility of displacement s in the longitudinal direction Z in the present case is approximately 7 times as large as the possibility of displacement in the transverse direction X and in the vertical direction

To define a maximum movement path in the transverse direction X, in the vertical direction Y and in the longitudinal direction Z, stops 37a to 37g are provided in the present case, each defining a defined end position of the structural unit 9 relative to the housing 5. The number and position of the stops 37a to 37g can in principle be freely selected, wherein at least one, in particular also two of the stops 37a to 37g are preferably provided for each direction X, Y, and Z on both sides of the structural unit 9.

During drilling or chiseling operation of the machine tool, vibrations or accelerations which act primarily in the direction of the impact axis arise due to the interaction between a ground to be processed and the tool 17. Due to the angle-shaped design of the machine tool 1, in which the center of mass 15 of the structural unit 9 does not lie on the impact axis or longitudinal axis Z, vibrations or accelerations transverse to the impact axis in the vertical direction Y are likewise produced as a result. For example, due to imbalance forces in the region of the drive device 13, vibrations or accelerations in the transverse direction X also occur during operation of the machine tool 1.

During operation of the machine tool 1, vibrations and accelerations occur in the region of the structural unit 9. These can be transmitted via the front decoupling apparatus 23 and the rear decoupling apparatus 25 to the housing 5 having the front grip region 27 and the rear grip region 7. The aim is to reduce or dampen the vibrations or accelerations arising during operation of the machine tool 1 in the region of the structural unit 9 as much as possible by means of the decoupling apparatuses 23, 25.

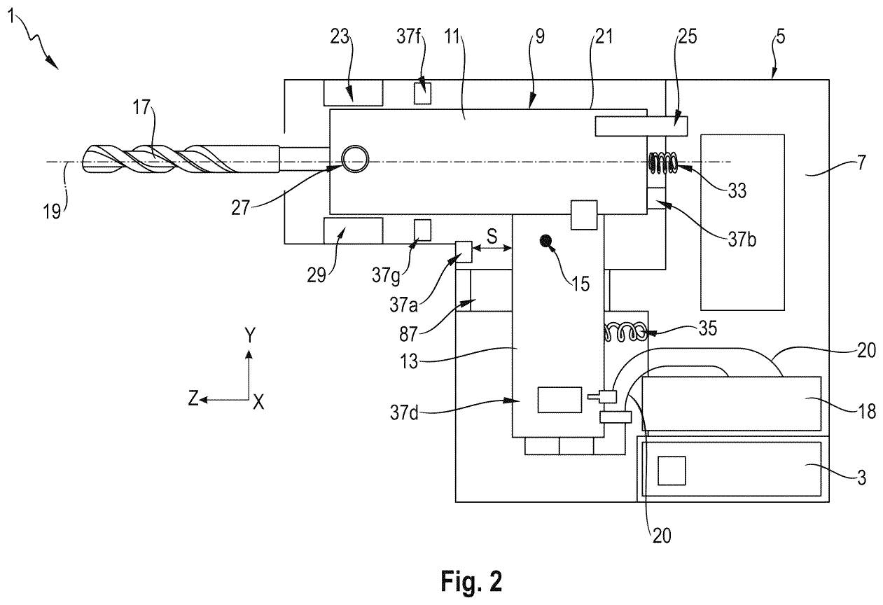

The assembly 9 is shown in FIG. 1 in the rest position in which the machine tool 1 is not operated or in which the assembly 9 is in contact with the front stop 37a in the front end position. In FIG. 2, the assembly 9 is shown in the rear end position and with the maximum deflection in the longitudinal direction Z, in which the assembly 9 is at the stops 37b.

In the exemplary embodiment according to FIG. 1 to FIG. 4, a lateral stop 37d assigned to the left side in the transverse direction X is shown, wherein another lateral stop (not shown) is correspondingly provided on a right side in the transverse direction X. The lateral stops 37d limit a movement path of the assembly 9 relative to the housing 5 in the transverse direction X.

In addition, an upper stop 37f and a lower stop 37g are provided in the present case, which limit a movement path of the assembly 9 with respect to the housing 5 in the vertical direction Y.

In the following, the rear decoupling apparatus 25 is first described in more detail.

In the present case, the rear decoupling apparatus 25 has a first decoupling device 31 and two second decoupling devices 33, 35.

The second decoupling devices 33, 35 of the rear decoupling apparatus 25 have spring properties and/or damping properties in the longitudinal direction Z and are realized here as spring devices with an axis of action substantially in the longitudinal direction Z.

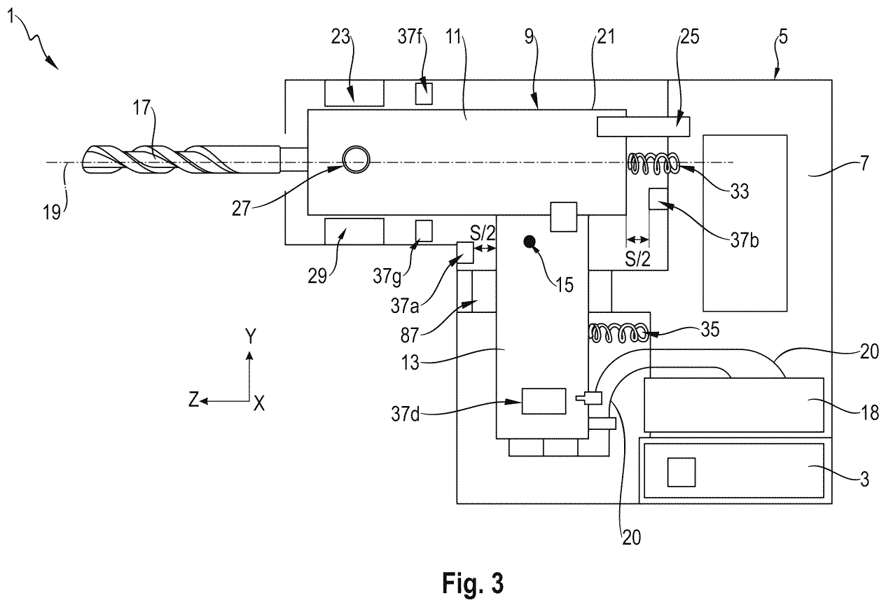

The spring devices 33, 35, designed here as a cylindrical helical spring, press the assembly 9 relative to the housing 5 in FIG. 1 into the front end position, in which the assembly 9 abuts the front stop 37a. FIG. 2 shows the spring devices 33, 35 in a maximally tensioned position. This position is assumed by the spring devices 33, 35 when the assembly 9 is in the rear end position relative to the housing 5, in which position the assembly 9 abuts the rear stops 37b, 37c. FIG. 3 shows the assembly 9 with respect to the housing 5 in a middle position in which a distance of the assembly 9 in the longitudinal direction Z from the front stop 37a and from the rear stops 37b, 37c is substantially identical and is approximately S/2.

The spring devices 33, 35 are arranged at a distance from one another in the vertical direction Y, wherein the spring device 33 in the present case is arranged in the region of the impact axis 19. In the present case, the spring device 35 is arranged in the region of the drive device 13 between the assembly 9 and the housing 5.

In alternative embodiments, additional second spring devices may also be provided, wherein for example two spring devices 35 arranged at a distance from one another in the transverse direction X may be provided. Alternatively or additionally thereto, additional spring devices arranged at a distance from one another in the vertical direction Y can also be provided.

In the embodiment according to FIG. 1 to 4, a single first decoupling device 31 is provided which is arranged at any position between the assembly 9 and the housing 5. It is particularly advantageous if a distance between a decoupling device 29 of the front decoupling apparatus 23 and the first decoupling device 31 in the longitudinal direction Z is as large as possible.

In alternative embodiments, a plurality of first decoupling devices 31 can also be provided which are arranged in particular spaced apart from one another in the vertical direction Y between the assembly 9 and the housing 5.

In FIG. 4, it is shown in a highly exaggerated manner that, during operation of the machine tool 1, the assembly 9 can rotate relative to the housing 5 about an axis extending in the transverse direction X. The assembly 9 can also rotate relative to the housing 5 about an axis running in the vertical direction Y and/or about an axis extending in the longitudinal direction Z. The front decoupling apparatus 23 and the rear decoupling apparatus 25 are designed such that they enable such rotations and, in particular, can also thereby dampen vibrations or accelerations transmitted.

In FIG. 1 to FIG. 4, another first decoupling device 36 is also shown which is arranged in a lower region of the machine tool 1 in the vertical direction Y between the assembly 9 and the housing 5. The further first decoupling device 36 is optional and may improve spring and/or damping properties.

In FIG. 5, the rear decoupling apparatus 25 has a single first decoupling device 31.

The first decoupling device 31 has a first sliding element 39, which is designed here as a pin-shaped element with a central axis 49. The pin-shaped element 39, which is designed as a steel pin, for example, is here positively connected to the housing 5 by means of a screw connection via a thread 41 arranged in the rear end region in the longitudinal direction Z. The first decoupling device 31 further comprises a second sliding element 43, which cooperates with the first sliding element 39 and serves as a sliding partner for it, and which is designed as a sliding bushing in the present case. The sliding bushing 43 interacts with a bearing block 47 fixed to the assembly via a decoupling element 45. In the present case, the bearing block 47 is connected to a transmission housing of the assembly 9 by a positive fit.

Here, the decoupling element 45 is fixed in the direction of the central axis 49 relative to the sliding bushing 43. Preferably, the sliding bushing 43, which is in particular made with plastic, is clipped into the decoupling element 45 for this purpose. In a region that is outer in the radial direction to the central axis 49, the decoupling element is fixed via a bushing 51 and the bearing block 47 in the direction of the central axis 49.

It can also be provided that the decoupling element 45 is glued relative to the sliding bushing 43 and/or relative to the bearing block 47.

The decoupling element 45 is in this case tubular with a substantially constant wall thickness. In an alternative embodiment, the decoupling element 45 can have a varying wall thickness circumferentially to the central axis 49.

In the present case, the decoupling element 45 is made with an elastomer. In the rest position of the assembly 9, the decoupling element 45 has pretension in the radial direction of the central axis 49 in order to achieve a desired radial stiffness in the transverse direction X and the vertical direction Y.

In the region of the first decoupling device 31, a rotation of the assembly 9 relative to the housing 5 is possible.

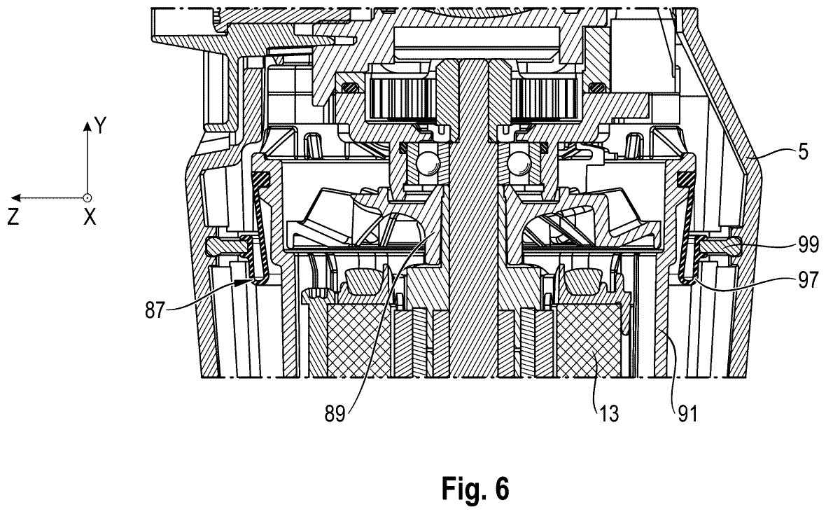

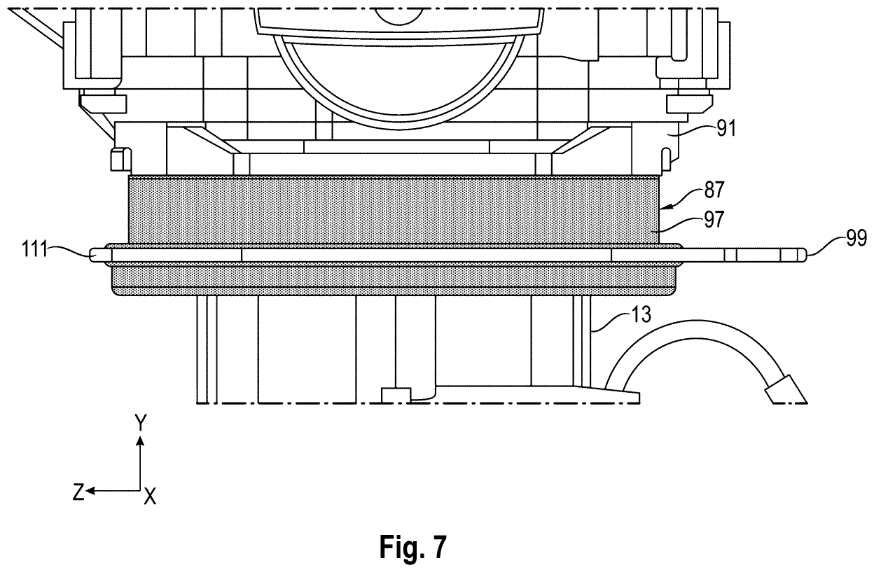

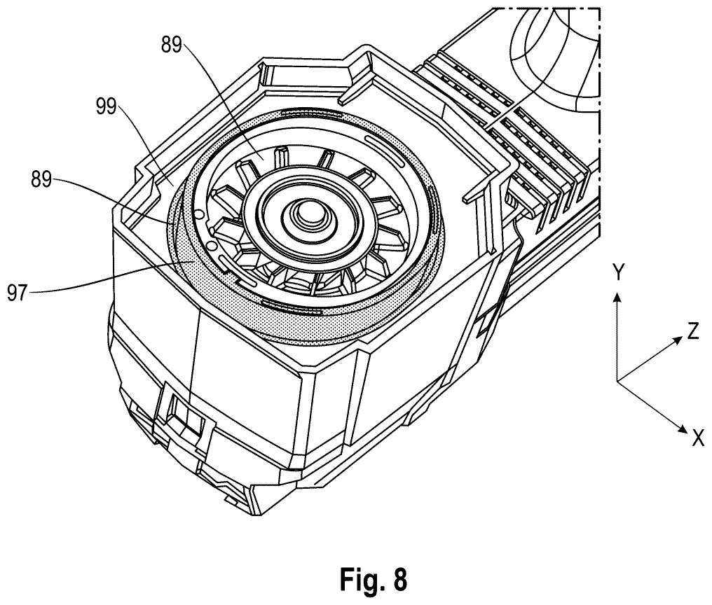

In addition to the embodiment shown in FIG. 6 with a first decoupling device 31, a further substantially structurally identical first decoupling device can also be provided, which can be arranged in a region lower with respect to the vertical direction Y, and in a region at the rear with respect to the longitudinal direction Z, of the assembly 9. In particular, such a further first decoupling device can be arranged in the region of the drive device 13.

Furthermore, FIG. 5 shows the decoupling device 29 of the front decoupling apparatus 23. The front decoupling device 29 has a first sliding element 75 fixed to the housing and a second sliding element 77 interacting with the assembly 9. The second sliding element 77 is arranged in a groove 79 of the assembly and is fixed substantially in the longitudinal direction Z relative to the assembly. The second sliding element 77 is pre-tensioned in the radial direction with respect to the longitudinal direction Z. For this purpose, a further groove 81 in which an O-ring 83 is arranged is provided within the groove 79 in the radial direction. The O-ring 83 acts on the second sliding element 77 with a force acting outward in the radial direction.

The first sliding element 75 is designed here as a steel bushing and is connected to the housing 5 in a positive-fitting manner. The steel bushing 75 is of a solid design such that it counteracts, to the desired extent, a deformation of the housing 9 in the region of the front grip area 27 due to its connection by means of a clamping band and the non-uniform circumferential forces that occur in the process.

The second sliding element 77 is designed in the present case with a slotted tubular ring made of plastic. Preferably, the second sliding element 77 is designed as a so-called Slydring®. As a result of the selected material pairing of the first sliding element 75 and of the second sliding element 77, good sliding properties are achieved which enable a displacement of the sliding elements 75 and 77 with respect to one another that occurs in particular in the longitudinal direction Z during operation. The interaction of the O-ring 83 and the second sliding element 77 allows the assembly 9 to rotate relative to the housing 5 in this area.

In FIG. 5, a sealing device 87 is also shown, by means of which a negative pressure side of the machine tool 1 is sealed between the assembly 9 and the housing 5 from a pressure side of the machine tool 1. The only open cross-section between the pressure side and the negative pressure side is provided by a fan 89 which is for building up pressure on the pressure side.

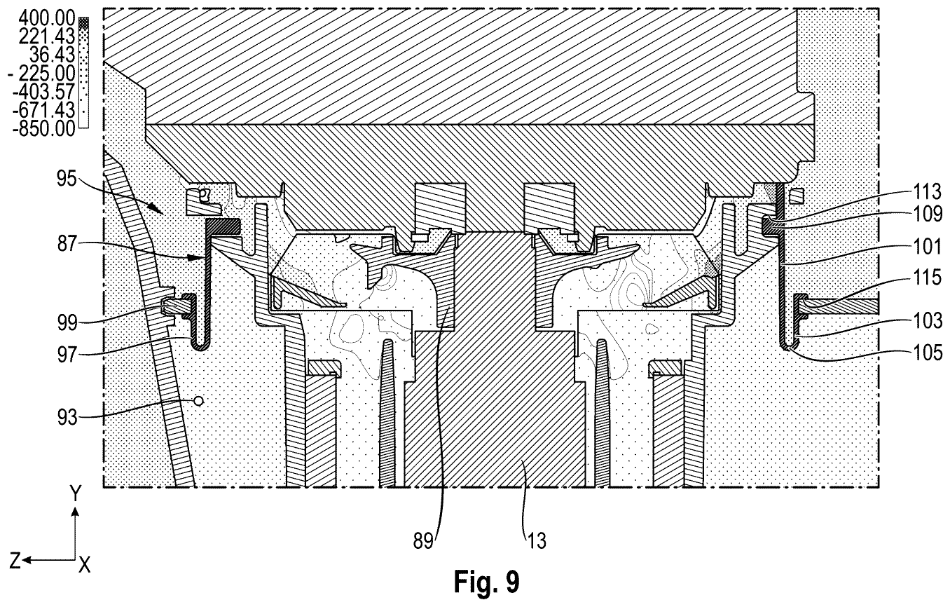

In FIG. 9, it can be seen that by means of the sealing device 87, there is a seal between an air intake region 93 which represents a negative pressure region, and an air outlet region 95 which represents a positive pressure region. This seal is ensured in all operating states of the machine tool 1 and accordingly when the assembly is in the front end position, or in the rear end position, or in an intermediate position therebetween in relation to the housing 9.

Furthermore, the sealing device 87 also seals reliably between the housing 5 and the assembly 9 when the assembly 9 is rotated relative to the housing 5 about an axis extending in the transverse direction X, vertical direction Y, and/or longitudinal direction Z.

In the present case, the sealing device 87 can be brought into engagement with a drive housing 91 of the drive device 13 by a lower side in the vertical direction Y, so that the sealing device 87 is connected to the drive housing 91 on a radially inner side in the mounted state. A lower region of the drive device 13 in the vertical direction Y is therefore free for the arrangement, for example, of cable harnesses which are connected to an outer side of the drive housing 91.

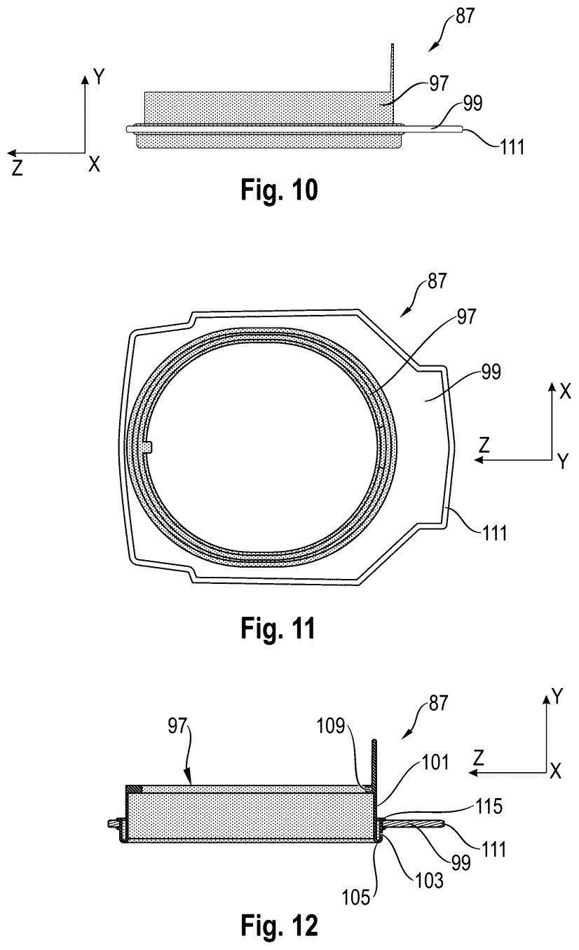

In the present case, the sealing device 87 or the air barrier shown in isolation in FIGS. 10, 11 and 12 has a flexible element 97 and a dimensionally stable element 99.

The flexible element 97 is preferably made with an elastomer and is made, for example, as an elastomer membrane. In the present case, the flexible element 97 has a U-shaped cross-section with two regions 101 and 103 extending substantially in the vertical direction Y, which are connected by means of a region 105 extending in the longitudinal direction Z. In the present case, the U-shaped cross-section is open upward substantially in the vertical direction Y. In an alternative embodiment, the U-shaped cross section can also be opened substantially downward in the vertical direction Y.

The flexible element 97 is connected to the dimensionally stable element 99 via a form-fit and/or material-fit, wherein the flexible element 97 is connected to the drive housing 91 by means of a form-fit. For this purpose, the flexible element 97 has a first region 109 connected to the region 101, which is designed, for example, as a circumferential lug, wherein the lug 109 can be brought into operative connection with a groove 113 of the drive housing 91.

The dimensionally stable element 99 is designed, for example, as a plastic frame, by means of which the sealing device 87 can be fixed to the housing 5. For this purpose, the housing 5 has, for example, a circumferential groove 107, in particular with respect to the vertical axis Y, into which the dimensionally stable element 99 can be inserted and fixed to a second region 111.

In order to connect the plate-shaped dimensionally stable element 99 to the flexible element 97, the flexible element 97 has a recess 115 which points outwards in the radial direction with respect to the vertical direction Y, into which recess 115 the dimensionally stable element 99 engages with an edge region.

The first region 109 is arranged further upward in the vertical direction Y with respect to the recess 115. As a result, in particular a large displacement of the assembly 9 relative to the housing 5 in the longitudinal direction Z can be compensated. In alternative embodiments, the first region 109 and the recess 115 can also lie approximately at the same height in the vertical direction Y, depending on the general conditions, or the first region 109 can be arranged further below than the recess 115.

FIG. 6 shows the assembly 9 in the middle position according to FIG. 3 with respect to the housing 5. The flexible element 97 is in a non-deformed and in particular non-tensioned position. This has the advantage that the flexible element 97 is not deformed to an undesirably large extent and is not exposed to undesirably large expansions and stresses, both when the assembly 9 is in the front end position and in the rear end position relative to the housing 5, and a sealing effect is not impaired.

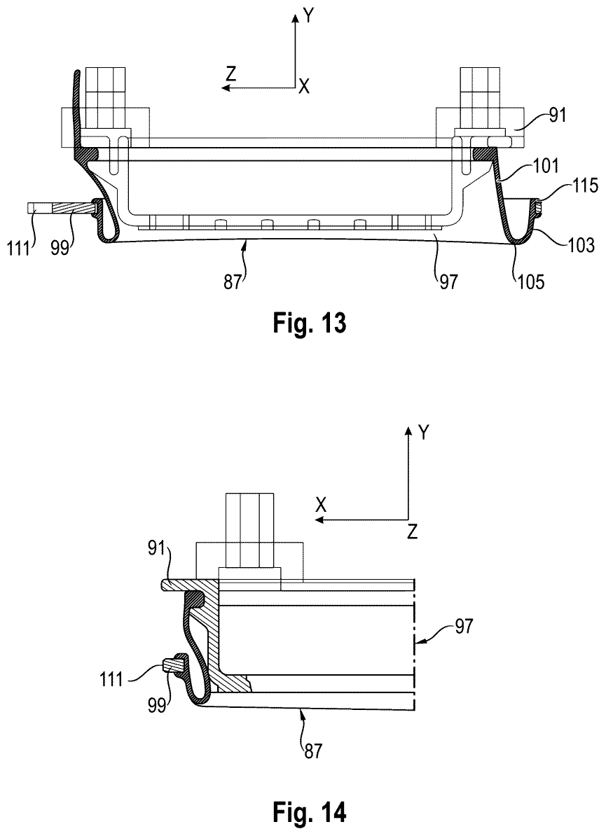

In FIGS. 13 and 14, a deformation of the flexible element 97 is shown, for example, which the flexible element 97 assumes when the assembly 9 is in the front end position relative to the housing 5.

What is claimed is:

1-12. (canceled)

13. A machine tool comprising:
a housing having a grip region;
an assembly including an impact mechanism and a drive device, the assembly being arranged within the housing movably relative to the housing, a center of gravity of the assembly being arranged at a distance from an impact axis; and
a seal device to restrict an air flow between the assembly and the housing, wherein the seal device is connected to the assembly and to the housing and encompasses the assembly circumferentially relative to a vertical direction of the machine tool.

14. The machine tool as recited in claim 13 wherein the seal device is connected fixedly to the housing with a first region and is connected fixedly to the assembly with a second region.

15. The machine tool as recited in claim 13 wherein the seal device has a flexible element and a dimensionally stable element.

16. The machine tool as recited in claim 15 wherein the flexible element has at least two regions extending substantially in the vertical direction and connected to one another in the longitudinal direction.

17. The machine tool as recited in claim 13 wherein the seal device has a U-shaped region in cross section.

18. The machine tool as recited in claim 13 wherein the seal device is connected to the assembly or the housing via a form-fit or material-fit.

19. The machine tool as recited in claim 14 wherein the seal device engages with the first region or second region in a recess of the housing or the assembly.

20. The machine tool as recited in claim 14 wherein the flexible element surrounds the dimensionally stable element in the circumferential direction of the vertical direction.

21. The machine tool as recited in claim 15 wherein the flexible element is made with an elastomer.

22. The machine tool as recited in claim 21 wherein the dimensionally stable element is made with a plastic.

23. The machine tool as recited in claim 15 wherein the dimensionally stable element is made with a plastic.

24. The machine tool as recited in claim 13 wherein the seal device is designed to allow a movement of the assembly relative to the housing in the longitudinal direction greater than 0.8 mm.

25. The machine tool as recited in claim 13 wherein the seal device is designed to allow a movement of the assembly relative to the housing in the longitudinal direction greater than 1.0 mm.

26. The machine tool as recited in claim 13 wherein the seal device is in a neutral position when the assembly is in an approximately central position between two end positions with respect to the housing relative to the longitudinal direction.

27. The machine tool as recited in claim 13 wherein the machine tool is a drill hammer or chisel hammer.
